(19) United States
(12) Patent Application Publication
(10) Pub. No.: US 2026/0084390 A1
(43) Pub. Date: Mar. 26, 2026

(54) FABRICATION OF PRE-CURED TREAD USING ADDITIVE MANUFACTURING TECHNIQUES

(71) Applicant: BRIDGESTONE BANDAG, LLC, Nashville, TN (US)

(72) Inventors: Terry A. Westaway, Muscatine, IA (US); John W. Whitley, Muscatine, IA (US); David L. Bender, Muscatine, IA (US)

(73) Assignee: BRIDGESTONE BANDAG, LLC, Nashville, TN (US)

(21) Appl. No.: 19/109,887

(22) PCT Filed: Aug. 14, 2023
(86) PCT No.: PCT/US2023/072145

§ 371 Date: Mar. 7, 2025

Related U.S. Application Data
(60) Provisional application No. 63/405,089, filed on Sep. 9, 2022.

(51) Int. Cl. B29D 30/52; B29K 105/00; B33Y 10/00; B33Y 80/00

(52) U.S. Cl. CPC B29D 30/52; B33Y 10/00; B33Y 80/00; B29K 2105/0097

(57) ABSTRACT

A method of forming a tread element is provided. The method includes forming, by a printer element of an additive manufacture assembly, a first layer of at least one material on a substrate. The first layer forms a tread element back side configured to couple to a tire casing. The method includes sequentially forming, by the printer element, a plurality of layers of the at least one material on the first layer across at least a portion of the tread element corresponding to a tread pattern. The plurality of layers defines a thickness of the tread element, and an outermost layer of the plurality of layers forms a tread element front side.

### FIELD

The present disclosure relates generally to the field of manufacturing tires. Specifically, the present disclosure relates to the fabrication of tread elements for tires.

### BACKGROUND

Additive manufacturing systems, sometimes referred to as 3D printing manufacturing systems, are typically configured to add or deposit material in a layer-by-layer process to fabricate structures.

### SUMMARY

One embodiment of the present disclosure relates to a method of forming a tread element. The method includes forming, by a printer element of an additive manufacturing assembly, a first layer of at least one material on a substrate. The first layer forms a tread element back side configured to couple to a tire casing. The method further includes sequentially forming, by the printer element, a plurality of layers of the at least one material on the first layer across at least a portion of the tread element corresponding to a tread pattern. The plurality of layers defines a thickness of the tread element. An outermost layer of the plurality of layers forms a tread element front side.

Another embodiment of the present disclosure relates to a method of forming a tread element. The method includes adding, using a printer element of an additive manufacturing assembly, a first layer of a first material to a substrate and adding, using the printer element, a plurality of layers of a second material on the first layer until a desired tread element thickness is formed. Each layer in the plurality of layers is stacked on and adhered to an immediately preceding layer. Multiple layers of the plurality of layers are added to a selected portion of the tread element, forming at least one groove extending into the plurality of layers.

Another embodiment of the present disclosure relates to a method of forming a tread element. The method includes providing an additive manufacturing assembly comprising a printer element including at least one energy source. The energy source is configured to cure a material. The method includes submerging a substrate in the material and directing energy from the energy source to a portion of a substrate and forming at least a portion of at least one layer of the material on the substrate. Each layer of the at least one layer of the material above a first layer is sequentially formed on an immediately preceding layer by selectively directing energy from the energy source, forming at least one groove in the tread element.

Another embodiment of the present disclosure relates to a method of forming a tread element. The method includes providing an additive manufacturing assembly. The additive manufacturing assembly includes a printer element configured to utilize one or more materials to fabricate the tread element and a material container or containers configured to store the one or more materials utilized by the printer element. The method further includes providing a substrate, positioning the substrate within the additive manufacturing assembly such that the one or more materials may be provided on the substrate, and operating the printer element to cause the one or more materials on the substrate to form the tread element.

Another embodiment of the present disclosure relates to a method of forming a tread element. The method includes causing a first layer of a first material to form on a substrate using a printer element of an additive manufacturing assembly, causing a second layer of a second material to form on the first layer, and causing a plurality of layers of the second material to form. Each layer of the plurality of layers is formed on a previous layer, without causing multiple layers of the plurality of layers to form over a portion of a width of the tread element to form at least one groove.

### BRIEF DESCRIPTION OF THE DRAWINGS

FIG. 1 is a front, cross-sectional view of a tire casing, according to an example embodiment,

FIG. 2 is a block diagram of a method of forming a tread element,

FIG. 3 is a front, cross-sectional view of a tread element, according to an example embodiment, and

FIG. 4 is a perspective view of the tread element of FIG. 3.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of. tire tread fabrication. The various concepts introduced above and discussed in greater detail below may be implemented in any number of ways, as the described concepts are not limited to any particular manner of implementation. Examples of specific implementations and applications are provided for illustrative purposes and are not intended to be limiting.

### I. Overview

Tires are used in various applications and under a variety of circumstances. Some tires may be designed to withstand the forces of a landing aircraft. Some tires may be designed to provide specific performance effects on surfaces covered in snow and ice. Some tires may be manufactured to be more suited to be repairable and retreaded.

Tires are used in applications ranging from aircraft landing gear to long-haul tractor-trailers to performance vehicles and generally, any vehicle. As a result, tread elements should be fabricated in a cost effective and efficient matter. Current methods include dispensing unvulcanized rubber into a mold and vulcanizing the rubber to form the tread element. These methods may require a plurality of molds for different tread designs.

Fabrication of tread elements using additive manufacturing according to the techniques of the present disclosure provides various benefits. For example, additive manufacturing methods facilitate the formation of a tread element without a mold. Further, in some cases, the vulcanization process may be eliminated or reduced, as the additive manufacturing method of the present techniques utilizes material to form the tread element by fabricating structures at specific locations on the substrate and may utilize materials that do not require vulcanization (e.g., thermoplastic filament), or that may be cured under a variety of conditions, such as cure temperatures significantly lower than the cure temperatures required to press tread. For example, additive manufacturing methods may extrude material onto specific locations of a substrate and then apply one or more curing sources to cure the material. As another example, additive manufacturing methods may deposit molten thermoplastic polymeric material at specific locations on a substrate that will solidify on cooling. Additive manufacturing methods may also include causing material to change phases from fluid material to a solid material directly on a substrate using one or more energy sources. Further, the fabrication of tread elements using additive manufacturing facilitates the formation of tread elements that possess various material characteristics throughout the entirety of the tread element, e.g., by utilizing various materials to form the tread element. Moreover, additive manufacturing may also allow for creation of various and complex tread element designs which are difficult or impossible to achieve through typical methods.

### II. Terms

As used herein, the term “cured” refers to a material that has been polymerized to achieve a crosslink density suitable for a specific application. Conversely, “uncured” refers to materials that are in their raw form and have not been cured.

As used herein, the term “precured tire tread” refers to a cured tire tread or build-up (e.g., precured product having no tread pattern thereon; blank; slick) that is separate from (e.g., not cured to) a tire casing. After a precured tire tread has been cured to a tire casing, the precured tire tread becomes a tire tread, and the combination of the precured tread cured to the tire casing forms a tire. The precured tire tread may take the form of a strip, oval, circle, ring, or similar shape.

As used herein, the term “tread element” may refer to a precured tire tread. The precured tire tread may include materials and features such as, but not limited to, studs, reinforcing fabrics, Kevlar, nylon, cords, and similar features and materials.

### III. Overview of Methods for Fabricating Tire Treads Using Additive Manufacturing

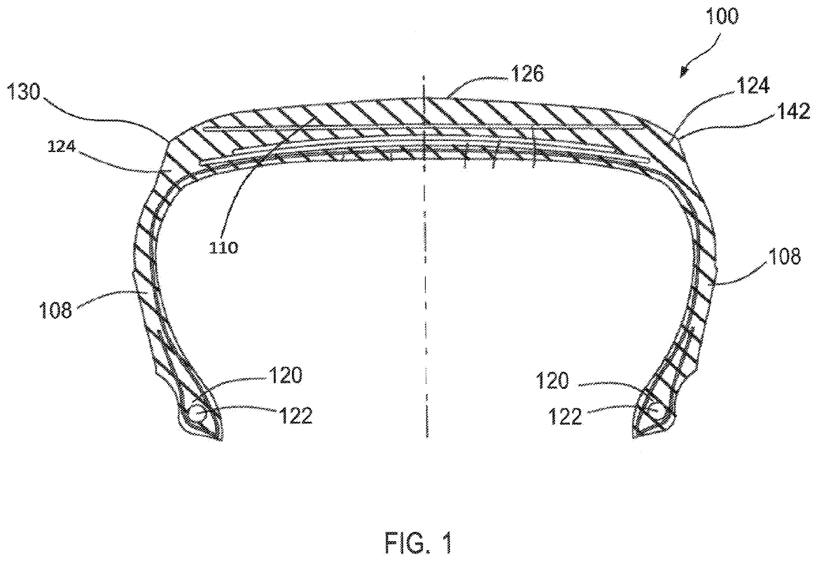

Referring to FIG. 1, a front, cross-sectional view of a tire casing (e.g., new tire casing, tire carcass, etc.) 100 is shown, according to an example embodiment. The tire casing includes a tread element mounting surface 126 (e.g., mounting surface, mating surface, bonding surface, curing surface, etc. ,) on the tire casing 100. The mounting surface 126 extends circumferentially about the tire casing 100 and extends axially across the outer wall 110 until it terminates proximate to the shoulder areas 124. The mounting surface 126 exhibits a curvature between the shoulder areas 124. In some embodiments, the mounting surface 126 is buffed to a slightly rounded (e.g., toroidal) radius extending between the shoulder areas 124. The tire casing 100 may be a radial tire or a bias ply tire, for example.

The tire casing 100 includes a pair of sidewalls 108 bounded by a generally radial outer wall 110 (e.g., crown, etc.) that extends between the sidewalls 108. Each of the sidewalls 108 extends radially inward from the outer wall 110 and terminates at a bead area 120 structured for mounting on a tire rim. The bead area 120 may be designed in a variety of configurations depending on, for example, tire type, tire size, or rim configuration. The bead area 120 includes a bead 122 that has metal strands or wires to improve the strength of the bead area 120.

The sidewalls 108 may include multiple layers, such as a rubber layer, a radial ply, and an inner liner, which cooperate to provide strong and flexible sidewalls 108. The sidewalls 108 are joined to the outer wall 110 and the tire tread 106 through a pair of shoulder areas 124. The shoulder areas 124 are contiguous with the sidewalls 108 and the outer wall 110. In some embodiments, the shoulder areas 124 are contiguous with the tire tread 106.

In some embodiments, the tire casing 100 is a new tire casing without a prior use history. The mounting surface 126 of the new tire casing is configured to receive a tread element.

In other embodiments, the tire casing may be from a tire with a use history. The use history may be such that the tread has been reduced in one or more locations so as to necessitate retreading. For example, in some instances after the tire tread of a tire is reduced beyond a certain limit, the tire is discarded, re-grooved, or retreaded before further use. In cold process retreading, what remains of the tire tread is removed from the tire casing 100 by a buffing machine through a buffing (e.g., removal) operation. During the buffing operation, the tire tread is ground away from the tire casing 100, leaving the tread mounting surface 126. During the buffing operation, a portion of the tire tread may be left behind on the tire casing 100, such as if it is desired to increase a thickness of the outer wall 110 before applying a tread element, as described herein, to the tire casing 100. Removal of the tire tread leaves behind (e.g., exposes, reveals, etc.) the mounting surface 126. After the tire tread is removed and the mounting surface 126 is exposed, skiving and filling may be performed on the tire casing 100. Skiving and filling include the removal of and filling of features (e.g., partially missing material, undesired material, scuffs, scratches, holes, nicks, punctures, tears, etc.) present in the tire casing 100 prior to a subsequent operation. The subsequent operation may be, for example, making a repair or performing a retread process. Often, the tire casing 100 accumulates features due to bits or other sharp objects the tire contacts during use. The features are first ground smooth by an appropriate cutting tool (e.g., sidewall buffer, wire brush, etc.), and then filled with repair gum (e.g., uncured rubber material, etc.). The affected areas may be filled to the level of the mounting surface 126 (e.g., such that the mounting surface 126 remains smooth) to avoid air pockets between the mounting surface 126 and the later applied tread element.

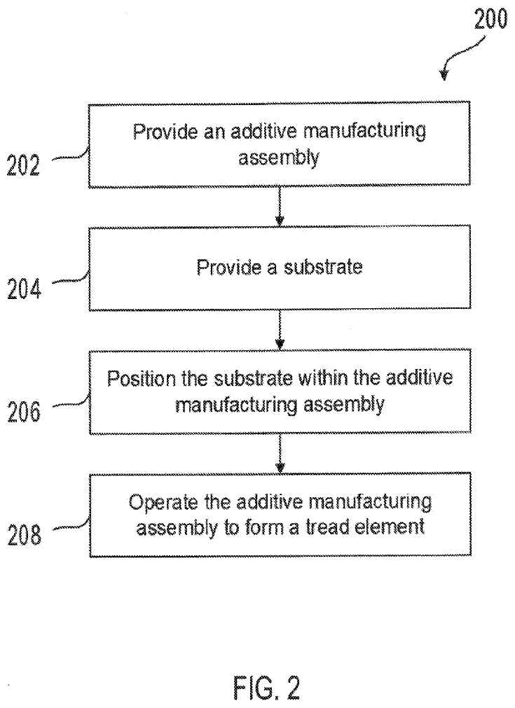

After a tire casing is obtained for a tire without a use history or after the buffing, skiving and filling operations for a tire with a use history are carried out, a tread element (e.g., a tire tread, etc.) is coupled to the tire casing 100. Referring to FIG. 2, a block diagram of a method 200 of forming the tread element is shown. In step 202, an additive manufacturing assembly (e.g., 3D printer assembly, fused deposition modeling assembly, direct ink writing assembly, digital light projection assembly, stereolithography assembly, powder bed fusion assembly, etc.) is provided. The additive manufacturing assembly includes a printer element. The printer element is configured to utilize at least one material (e.g., first material, second material, etc.) to print the tread element.

In some embodiments, the printer element is an extruder which is configured to extrude the material to form the tread element. In some embodiments, the printer element is a component of a printer such as a print head. The printer element may include one or a plurality of energy sources (e.g., visible light emitters, ultraviolet light emitters, arc lamps, infrared emitters, radio wave emitters, gamma ray emitters, microwaves, radiation emitters, etc.). As discussed in more detail below, exposing the material to one or more of the energy sources can cause polymerization and/or curing of the material. The exposure to the one or more energy sources causes the material to change from a first state, such as a fluid state, to a second state, such as a solid state.

In some embodiments, the material is stored in a material container which is provided with or integrated into the additive manufacturing assembly. That is, the material container (e.g., vat, syringe, dispenser, reservoir, cartridge, etc.) serves as a reservoir for storing the material which is utilized to form the tread element. The material container is coupled to the printer element. The material may be or include one or more rubber, natural rubber, synthetic rubber, liquid rubber, liquid polyurethane, polyurethane and various polymers and compounding ingredients, such as carbon black, silica, anti-degradants, and zinc oxide or any combination thereof. The material may also be or include one or more amine compounds, hydroxyl functionalized compounds, isocyanate functionalized compounds, or epoxide functionalized compounds. In some embodiments, more than one container may be used to store more than one material.

In some embodiments, the material may be a solid material (e.g., filament, powder, pellets, etc.). In some embodiments, the material may be a fluid material. The material may be uncured. In some embodiments, when the material is uncured, the material is cross linked in the additive manufacturing process such that it achieves a lower degree of curing to facilitate bonding between the layers and between the formed tread element and the tire casing.

In step 204, a substrate is provided. The substrate may be formed to be substantially planar. In some embodiments, the substrate may be curved. In other embodiments, the substrate is the mounting surface 126. The substrate may have an adhesive configured to facilitate adhesion to the material dispensed from the printer element, as described herein. In some embodiments, such as some methods in which the printer element is a plurality of energy sources, the substrate may have stronger adhesion properties. In step 206, the substrate is positioned within the additive manufacturing assembly. The substrate is coupled to a printing platform of the additive manufacturing assembly such that the material may be provided on the substrate (e.g., by being directly deposited or cured thereon). In some embodiments, the substrate is positioned within a container containing a material capable of being utilized by the printing element to form a tread element.

In step 208, the additive manufacturing assembly is operated to form the tread element. In some embodiments when the material is a solid material, the printer element is operated to receive the material from the material container. The printer element may extrude the material from the printer element on to the substrate in a layer formation. Specifically, the printer element may extrude a first layer of material on to the substrate. In some embodiments, the first layer may be of a first material, for example, one or more functionalized polymer components of an amine/isocyanate, amine/epoxide, or hydroxyl/isocyanate reactive adhesive system. The first layer may be formed so as to exhibit patterning. For example, some embodiments may have a cross-hatching pattern to mimic buffing on a tire casing to facilitate adhesion to buffed tread mounting surface 126. In some embodiments, the first layer of material may include slick which is molded to the first layer of material.

Following the first layer, the additive manufacturing assembly is operated such that the printer element forms a plurality of layers. The plurality of layers is formed sequentially after the first layer such that a second layer adheres to the first layer and a third layer adheres to the second layer. The plurality of layers may be formed from a second material which is different from the first material. In some embodiments, the first material and the second material are the same such that the first layer is formed of the same material as the plurality of layers. In some embodiments, different materials are utilized to form a layer, such that the layer contains portions with different material compositions. In some embodiments, different materials are utilized to form the plurality of layers such that adjacent portions of adjacent layers have different material compositions. In some embodiments, adjacent portions of adjacent layers contain different components of a multicomponent reactive adhesive system including, but not limited to, amine/isocyanate, amine/epoxide or hydroxyl/isocyanate reactive adhesive systems to facilitate interlayer bonding. As the tread element begins to form by the plurality of layers of material, the additive manufacturing assembly is operated such that grooves are formed on the tread element. Specifically, the printer element is configured to stop depositing, curing, or otherwise solidifying material across a portion of the width and the length of the tread element after a desired number of layers are formed. Consequently, the thickness of the tread element around the portion where no material is deposited or cured increases, causing the groove to form in the tread element.

In some embodiments, the additive manufacturing assembly is operated such that the tread element formed includes sipes, as described herein. Specifically, the printer element of the additive manufacturing assembly is configured to stop extruding material across a portion of the length and width of the tread element. The portion of the tread element in which sipes are formed is a different portion of the tread element in which the groove is formed, as described herein.

As described above, when the material is a fluid, the printer element is operated to cause the material to transition from a fluid state to a solid state. More particularly, in some embodiments, the substrate is submerged in material and the printer element is operated so that energy is directed to a portion of the substrate. The exposure of the material to the energy causes the material to harden and adhere to the substrate. In some embodiments, the substrate may be submerged in the material container when the material container includes the first material such that a first layer is formed of the first material. The substrate can remain submerged in the material container (containing un-polymerized fluid) as a plurality of layers are formed. In some embodiments, the substrate including the first layer may then be submerged in the second material and a plurality of layers are formed to form the tread element. In some embodiments, portions of a layer or portions of a plurality of layers may be formed in a first material container. The substrate containing the portions of a layer or portions of a plurality of layers may be submerged in a container of a second material and portions of a layer or portions of a plurality of layers may be formed by utilizing the second material. The substrate containing portions of the layer or portions of the plurality of layers may be submerged in containers containing additional materials to form tread elements comprised of portions of a plurality of materials. Further, during the formation of the tread element, grooves and sipes may be formed in the tread element. Specifically, the printer element is operated so that energy is selectively directed, meaning the energy does not interact with (e.g., contact or be directed to) a portion of the width of the tread element such that when the substrate is removed from the material container, the tread element includes grooves and sipes.

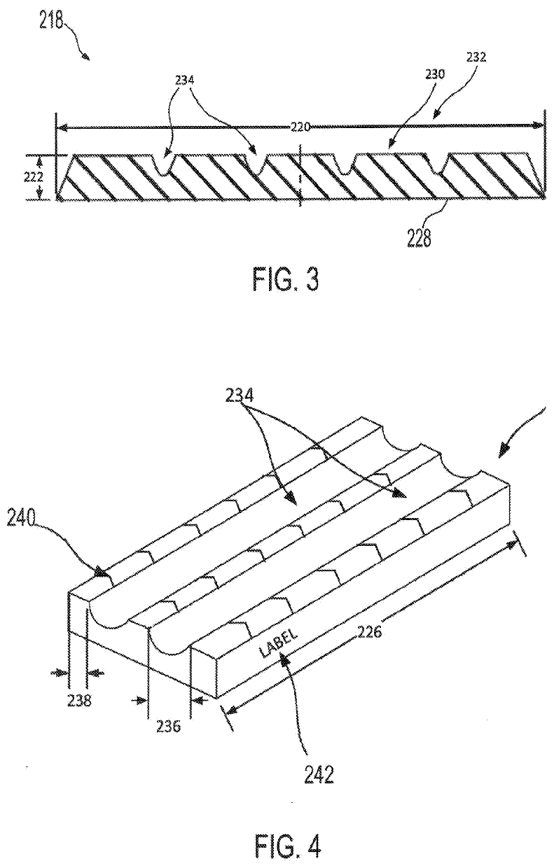

Referring to FIGS. 3 and 4, a tread element 218 formed by the method 200 is shown. The tread element 218 may be formed in a strip having a tread width 220 corresponding to a width of the mounting surface 126 between the shoulder areas 124. The tread width 220 may be in a range (e.g., within 5% or 10% of) of approximately 5.5 inches (in) and approximately 10.5 inches, inclusive (e.g., about 5.7 in., about 6 in., about 7 in., about 8 in., about 9 in., about 10 in., about 10.5 in., etc.). The tread width 220 may be in a range of approximately 195 millimeters (mm) to approximately 260 mm (e.g., 195 mm, 210 mm, 215 mm, 220 mm, 225 mm, 230 mm, 235 mm, 240 mm, 245 mm, 250 mm, 255 mm, 260 mm, 273 mm, etc.). Additionally, the tread element 218 has a tread thickness 222 (e.g., element thickness or a tread span that is an extent of the tread element in a thickness direction). The tread thickness 222 may be in a range of approximately 0.285 inches and approximately 2.2 inches, inclusive (e.g., about 0.285 in., about 0.3 in., about 0.5 in., about 0.75 in., about 1 in., about 1.25 in., about 1.5 in., about 1.75 in., about 2 in., about 2.1 in., etc.). Moreover, the tread element 218 may be formed in a strip having a length 226 approximately in a range of 3.8 feet (ft.) to 12.5 ft. (e.g., 3.8 ft., 4 ft., 4.5 ft. 5 ft., 5.5 ft., 6 ft., 6.5 ft., 7 ft., 7.5 ft., 8 ft., 8.5 ft., 9 ft., 9.5 ft., 10 ft., 10.5 ft., 11 ft., 11.5 ft., 12 ft., 12.5 ft., etc.).

The tread element 218 formed by the method 200 may have various material properties (e.g., wear resistance, tear resistance, rolling resistance, wear abrasion etc.) at different locations on the tread element 218. In some embodiments, the material properties may vary at different locations of the tread element 218 with respect to a relatively large degree of spatial resolution. The tread element 218 may have a rolling resistance, as measured by 100 C tan(δ), ranging from approximately 0.03 to approximately 0.30 in some embodiments. In some embodiments, the tread element 218 is formed such that a portion of the tread element 218 has a first rolling resistance and another portion of the tread element has a second rolling resistance where the second rolling resistance is different from the first rolling resistance. The tread element 218 formed by the method 200 may have a tear resistance, as measured by tensile elongation at break, approximately 200%-800% (e.g., 200%, 250%, 300%, 350%, 400%, 450%, 500%, 550%, 600%, 650%, 700%, 750%, 800%, etc.). In some embodiments, a portion of the tread element 218 may have a first tear resistance and another portion of the tread element 218 may have a second tear resistance, wherein the second tear resistance is different from the first tear resistance. Specifically, the tread element 218 may be configured to have various rolling resistances and tear resistances across the entirety of the tread element by varying the materials utilized during the fabrication process and their extent of cure. For example, the material utilized by the printer element may be changed while fabricating a layer of the plurality of layers so that the middle of the layer may have a different rolling resistance or tear resistance than one of the ends of the layer. In some embodiments, the tread element 218 may have wear abrasions, which are equivalent to tread elements formed using customary methods (e.g., molding, etc.).

The tread element 218 includes a tread element back side 228 (e.g., generally planar mounting surface, continuous surface, mating surface, binding surface, etc.). The tread element back side 228 is formed from the first layer in the additive manufacturing process. The tread element back side 228 is configured to be applied on to (e.g., disposed on, etc.) the mounting surface 126 such that the tread element 218 may be coupled to the tire casing 100. For example, cushion gum may be applied to the mounting surface 126 and the tread element 218 may be applied to the cushion gum such that the tread element back side 228 is positioned on the cushion gum. In the process of forming the final tire, the tire casing, the cushion, and the tread element may be vulcanized so that the tread element is fixedly coupled to the tire casing.

In some embodiments, the tread element back side 228 is partially formed from, but is not limited to, one or more isocyanate functionalized compounds, epoxide functionalized compounds, hydroxyl functionalized compounds, or amine functionalized compounds. Moreover, the cushion gum applied to the mounting surface may also contain, but is not limited to, one or more amine functionalized compounds, hydroxyl functionalized compounds, isocyanate functionalized compounds, or epoxide functionalized compounds such that components of the back side 228 are capable of forming covalent bonds with components of the cushion in a reactive adhesive system. For example, a layer of the tread (e.g., first layer, etc.) is formed from a first material (e.g., one or more amine compounds, one or more isocyanate functionalized elastomers, etc.). The cushion gum includes a second material (e.g., one or more amine compounds, one or more isocyanate functionalized elastomers, etc.) where the second material is different from the first material. As the tread element back side 228 is positioned on the cushion gum, covalent bonding between the first material and the second material is facilitated. The covalent bonding may occur as the formation of urethane groups, urea groups, amine groups, or ether groups. This bonding provides improved coupling between the tread element 218 and the cushion gum.

Referring to FIGS. 3-4, the tread element 218 includes a tread element front side 230 (e.g., generally planar opposing surface, road-contacting surface, tread surface, etc.), which is opposite to the tread element back side 228 and is configured to engage with a road surface. The tread element front side 230 may include a tread pattern 232 (e.g., a tread design, a series of treads, a tread pattern repetition, etc.). The tread pattern 232 includes a plurality of tread grooves 234. The plurality of tread grooves 234 may be configured to channel water and provide performance effects during certain road and weather conditions.

The plurality of tread grooves 234 are formed during the fabrication of the tread element 218 in method 200. Specifically, during the fabrication process, the printer assembly is operated such that the printer element does not extrude solid material, or the printer element is otherwise not operated (e.g., without energy emission) for a portion of the width 236 of the tread element 218 for a plurality of layers. In this manner, e.g., by not performing one or more operations such as extrusion or otherwise not performing actions to allow deposition and/or curing of material, the tread groove 234 forms. In some embodiments, a plurality of tread grooves 234 are formed. In some embodiments, extrusion of material may first be performed and then stopped to allow formation of at least one groove. The plurality of tread grooves 234 may have a width 236 approximately in a range between 0.095 in. and 1.05 in. (e.g., 0.095 in., 0.1 in., 0.2 in. 0.3 in., 0.4 in., 0.5 in., 0.6 in., 0.7 in., 0.8 in., 0.9 in., 1 in., 1.05 in. etc.). In some embodiments, a first tread groove 234 may have a first width 236 and a second tread groove 234 of the plurality of tread grooves 234 may have a second width 236, where the second width 236 is different from the first width 236.

The tread pattern 232 includes a plurality of sipes 240 which are formed during the fabrication of the tread element 218 in method 200. The sipe 240 extends across a portion of the width 238 of the tread element. The portion of the width is approximately in a range of 0.095 in. and 1.05 in. (e.g., 0.095 in., 0.1 in., 0.2 in. 0.3 in., 0.4 in., 0.5 in., 0.6 in., 0.7 in., 0.8 in., 0.9 in., 1 in., 1.05 in. etc.). In some embodiments, the sipes are formed because the printer element does not extrude material or otherwise operate (e.g., emitting energy) over a portion of the length the tread element. The portion of the length in which the printer element is not operated defines the thickness of the sipe.

In some embodiments, the tread element may include a label 242. The label 242 is configured to be a design or indication that is provided on the tread element 218. Specifically, during the fabrication process, the printer element deposits material or emits energy, depending on the fabrication process as described above, such that the material cures and the label 242 is formed as at least one raised region or at least one patterned groove on the tread element. For example, as seen in FIG. 4, the sidewall of the tread element may include the label 242 “LABEL,” to identify the manufacturer of the tread element. The label 242 may be any indicator, for example, manufacturer name, serial number, logos, etc. In some embodiments, the label 242 may be an RFID label.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures may show a specific order of method steps, the order of the steps may differ from what is depicted. In some embodiments, two or more steps may be performed concurrently or with partial concurrence. All such variations are within the scope of the disclosure. While various aspects and embodiments have been disclosed herein, other aspects and embodiments will be apparent to those skilled in the art. The various aspects and embodiments disclosed herein are for purposes of illustration and are not intended to be limiting, with the scope and spirit of the disclosure being indicated by the following claims.

1. A method of forming a tread element, the method comprising:
forming, by a printer element of an additive manufacturing assembly, a first layer of at least one material on a substrate, the first layer forming a tread element back side configured to couple to a tire casing; and
sequentially forming, by the printer element, a plurality of layers of the at least one material on the first layer across at least a portion of the tread element corresponding to a tread pattern, the plurality of layers defining a thickness of the tread element,
wherein an outermost layer of the plurality of layers forms a tread element front side.

2. The method of claim 1, wherein the tread pattern includes at least one of a plurality of grooves or a plurality of sipes.

3. The method of claim 1, wherein at least one layer of the plurality of layers is also formed from a second material such that the at least one layer contains portions formed from the second material.

4. The method of claim 1, wherein the at least one material includes at least one component of a reactive adhesive system.

5. The method of claim 1, wherein the plurality of layers contains complementary components of a reactive adhesive system such that adjacent portions of adjacent layers within the plurality of layers bond, facilitating interlayer bonding.

6. The method of claim 1, wherein the at least one material is a solid material.

7. The method of claim 1, wherein the at least one material is a fluid material.

8. The method of claim 1, wherein the substrate comprises a cushion gum configured to be applied on a mounting surface of the tire casing.

9. The method of claim 8, wherein the cushion gum and the first layer contain complementary components of a reactive adhesive system such that the cushion gum and the first layer bond.

10. A method of forming a tread element, the method comprising:
adding, using a printer element of an additive manufacturing assembly, a first layer of a first material to a substrate; and
adding, using the printer element, a plurality of layers of a second material on the first layer until a desired tread element thickness is formed, each layer in the plurality of layers stacked on and adhering to an immediately preceding layer,
wherein multiple layers of the plurality of layers are added to a selected portion of the tread element, forming at least one groove extending into the plurality of layers.

11. The method of claim 10, wherein the first material and the second material contain complementary components of a reactive adhesive system such the first material and the second material are capable of bonding.

12. The method of claim 11, wherein at least one component of the complementary components incudes at least one of isocyanate functionalized compounds, epoxide functionalized compounds, hydroxyl functionalized compounds, or amine functionalized compounds.

13. The method of claim 10, wherein the substrate comprises a cushion gum configured to be applied on a mounting surface of a tire casing.

14. The method of claim 13, wherein the cushion gum and the first layer contain complementary components of a reactive adhesive system such that the cushion gum and the first layer bond.

15. A method of forming a tread element, the method comprising:
providing an additive manufacturing assembly comprising a printer element including at least one energy source, the at least one energy source configured to cure a material;
submerging a substrate in the material; and
directing energy from the at least one energy source to a portion of the substrate and forming at least a portion of at least one layer of the material on the substrate,
wherein each layer of the at least one layer of the material above a first layer is sequentially formed on an immediately preceding layer by selectively directing energy from the at least one energy source, forming at least one groove in the tread element.

16. The method of claim 15, further comprising:
submerging the substrate including the at least one layer in a second material; and
sequentially forming a plurality of layers of the second material on the at least one layer, each layer of the plurality of layers formed by selectively directing energy from the at least one energy source, forming the at least one groove in the tread element.

17. The method of claim 16, wherein a portion of the at least one layer of the material is also formed from the second material such that the at least one layer contains portions formed from the second material.

18-22. (canceled)

23. The method of claim 2, wherein the tread pattern includes the plurality of grooves and the plurality of sipes.

24. The method of claim 3, wherein at least one layer of the plurality of layers is also formed from a third material such that the at least one layer contains portions formed from the third material.

25. The method of claim 5, wherein at least one component of the complementary components incudes at least one of isocyanate functionalized compounds, epoxide functionalized compounds, hydroxyl functionalized compounds, or amine functionalized compounds.
